(19) United States
(12) Patent Application Publication
(10) Pub. No.: US 2015/0282136 A1
(43) Pub. Date: Oct. 1, 2015

(54) Scheduling in a Communication Network

(71) Applicant: Neul Ltd., Cambridge (GB)

(72) Inventors: Steven Wenham, Burwell (GB); John Andrew, Cambridge (GB); Christopher Kevan Lowe, St. Neots (GB)

(21) Appl. No.: 14/667,166

(22) Filed: Mar. 24, 2015

(30) Foreign Application Priority Data
Mar. 25, 2014 (GB) 1405273.2

(51) Int. Cl. H04W 72/04; H04W 4/00

(52) U.S. Cl. CPC H04W 72/042; H04W 4/005; H04W 88/12

(57) ABSTRACT

A scheduler for allocating communication resources to terminals that are operating in a communication network comprising a plurality of cells, the scheduler comprising a macro-scheduler configured to, for the plurality of cells, allocate the communication resources available to each cell between the terminals in that cell using a first scheduling algorithm and a micro-scheduler configured to allocate the communication resources available to one of the cells between the terminals in that cell using: (i) the macro-scheduler's allocation of communication resources between those terminals; and (ii) a second scheduling algorithm.

### CROSS-REFERENCE TO RELATED APPLICATIONS

This application claims priority to UK Patent Application No. 1405273.2 titled “Scheduling in a Communication Network,” which was filed on Mar. 25, 2014. The disclosure of the foregoing application is incorporated herein by reference in its entirety.

### TECHNICAL FIELD

This invention relates to a scheduler for allocating resources in a communication network.

### BACKGROUND

Most wireless communication systems have finite communication resources available to them, usually because they are only permitted to transmit over a limited bandwidth. That bandwidth needs to be allocated between the devices in the system so that each gets its turn. Individual devices are usually allocated part of the bandwidth for a time. They may also be allocated one of a group of orthogonal codes. Scheduling is normally carried out locally within a cell, even in communication systems that comprise multiple cells. A single scheduling entity is typically in control of this activity. For most communication systems this works well as all of the capabilities and information required to schedule communications are available locally.

Machine-to-machine (M2M) radio systems are different. This is due to a number of factors. One factors is that cell sizes are typically much larger; an M2M system may have cell sizes of more than 100,000 terminals. These terminals may have very low data transfer rates. Another factor is that terminals may not be accessible all of the time due to the need to conserve battery life. Therefore, there is a need for an improved scheduler for an M2M system.

### SUMMARY

According to one embodiment, there is provided a scheduler for allocating communication resources to terminals that are operating in a communication network comprising a plurality of cells, the scheduler comprising a macro-scheduler configured to, for the plurality of cells, allocate the communication resources available to each cell between the terminals in that cell using a first scheduling algorithm and a micro-scheduler configured to allocate the communication resources available to one of the cells between the terminals in that cell using: (i) the macro-scheduler's allocation of communication resources between those terminals; and (ii) a second scheduling algorithm.

The macro-scheduler may be configured to prioritise one cell over another if it determines that this is likely to increase performance across the plurality of cells.

The macro-scheduler may be capable of muting one cell so as to be able to allocate communication resources in another cell.

The macro-scheduler may be configured to designate an allocation of communication resources to a terminal as mandatory or suggested.

The micro-scheduler may be configured to always implement an allocation of communication resources that the macro-scheduler has designated as mandatory.

The micro-scheduler may be configured to optionally implement an allocation of communication resources that the macro-scheduler has designated as suggested.

The micro-scheduler may be configured to implement a suggested allocation in dependence on the second scheduling algorithm.

The micro-scheduler may be configured to not to implement the suggested allocation if it determines that not implementing it is likely to increase performance across the one cell.

The macro-scheduler may be configured to assign a policy to a suggested allocation which sets out conditions under which the micro-scheduler is permitted not to implement the suggested allocation.

The macro-scheduler may be configured to assign a policy which sets out allocation boundaries within which the micro-scheduler is permitted to vary the macro-scheduler's suggested allocation.

The macro-scheduler may be configured to assign a policy which sets out allocation boundaries that the micro-scheduler is not permitted to exceed.

The micro-scheduler may be configured to comply with the policy assigned to a suggested allocation.

The micro-scheduler may be configured to provide feedback to the macro-scheduler on the relative success of a particular allocation of communication resources in the one cell.

The macro-scheduler may be configured to allocate communication resources between the terminals in the one cell in dependence on feedback it has received from the micro-scheduler.

The macro-scheduler may be configured to allocate communication resources between terminals in one cell in dependence on feedback it has received about the relative success of an allocation of communication resources in another cell.

The macro-scheduler may be configured to allocate communication resources to one or more terminals in the one cell in order to receive feedback from the micro-scheduler on the relative success of that allocation.

The macro-scheduler may be configured to allocate the communication resources to the one or more terminals in order to receive feedback to assist it in scheduling communications with other terminals.

The macro-scheduler may be configured to allocate the communication resources to one or more terminals to assist in scheduling communications with terminals that are less flexible in their resource requirements than the one or more terminals.

The macro-scheduler may be configured to allocate the communication resources responsive to a change in the communication network.

The macro-scheduler may be configured to command the micro-scheduler to enter a survey mode of operation in which the micro-scheduler allocates communication resources between the terminals in the cell to gather information about interference in the cell.

The micro-scheduler may be configured to, responsive to the macro-scheduler's command, command a base station to enter a survey mode of operation in which it operates to gather information about interference in the cell.

The micro-scheduler may be configured to, responsive to the macro-scheduler's command, command the one or more terminals to enter a survey mode of operation in which they use communication resources allocated to them to gather information about interference in the cell.

The macro-scheduler may be configured to allocate communication resources for future frames.

The micro-scheduler may be configured to allocate resources on a frame-by-frame basis.

The macro-scheduler may be configured to communicate with another micro-scheduler, which is configured to allocate communication resources between terminals in a different cell from the one cell, and to allocate communication resources between the terminals in the one cell in dependence on information received from the other micro-scheduler.

According to a second embodiment, there is provided a method for allocating communication resources to terminals that are operating in a communication network comprising a plurality of cells, the method comprising allocating, for the plurality of cells, the communication resources available to each cell between the terminals in that cell using a first scheduling algorithm and allocating the communication resources available to one of the cells between the terminals in that cell using: (i) the macro-scheduler's allocation of communication resources between those terminals; and (ii) a second scheduling algorithm.

According to a third embodiment, there is provided a scheduler for allocating communication resources to terminals that are operating in a communication network comprising a plurality of cells, the scheduler comprising an allocation unit configured to, for the plurality of cells, allocate the communication resources available to each cell between the terminals in that cell using a first scheduling algorithm, a designation unit configured to designate an allocation of communication resources to a terminal as mandatory or suggested and a communication unit configured to communicate the allocations and their associated designations to another scheduler.

The allocation unit may be configured to prioritise one cell over another if it determines that this is likely to increase performance across the plurality of cells.

The scheduler may be capable of muting one cell so as to be able to allocate communication resources in another cell.

The scheduler may comprise a policy unit configured to assign a policy to a suggested allocation which sets out conditions under which the other scheduler is permitted not to implement the suggested allocation.

The policy unit may be configured to assign a policy which sets out allocation boundaries within which the other scheduler is permitted to vary the macro-scheduler's suggested allocation.

The policy unit may be configured to assign a policy which sets out allocation boundaries that the other scheduler is not permitted to exceed.

The allocation unit may be configured to allocate communication resources between the terminals in one cell in dependence on feedback it has received from the other scheduler on the relative success of previous allocations in that cell.

The allocation unit may be configured to allocate communication resources between terminals in one cell in dependence on feedback it has received about the relative success of an allocation of communication resources in another cell.

The allocation unit may be configured to allocate communication resources to one or more terminals in order to receive feedback from the other scheduler on the relative success of that allocation.

The allocation unit may be configured to allocate the communication resources to the one or more terminals in order to receive feedback to assist it in scheduling communications with other terminals.

The allocation unit may be configured to allocate the communication resources to one or more terminals to assist in scheduling communications with terminals that are less flexible in their resource requirements than the one or more terminals.

The allocation unit may be configured to allocate the communication resources responsive to a change in the communication network.

The communication unit may be configured to command the other scheduler to enter a survey mode of operation, in which the other scheduler allocates communication resources between the terminals in a cell to gather information about interference in that cell.

The allocation unit may be configured to allocate communication resources for future frames.

According to a fourth embodiment of the invention, there is provided a scheduler for allocating communication resources to terminals that are operating in a cell of a communication network, the scheduler comprising an input configured to receive an allocation of communication resources between the terminals in the cell from another scheduler, and an allocation unit configured to allocate the communication resources available to the cell between the terminals in the cell using: (i) the other scheduler's allocation of communication resources between those terminals; and (ii) a scheduling algorithm that is different from the scheduling algorithm used by the other scheduler to generate the received allocation of communication resources.

The allocation of communication resources received from the other scheduler may be designated by that scheduler as mandatory or suggested, the allocation unit being configured to always implement an allocation of communication resources that the other scheduler has designated as mandatory and optionally implement an allocation of communication resources that the other scheduler has designated as suggested.

The allocation unit may be configured to implement a suggested allocation in dependence on its scheduling algorithm.

The allocation unit may be configured to not to implement a suggested allocation if it determines that not implementing it is likely to increase performance across the one cell.

A suggested allocation from the other scheduler may be assigned a policy which sets out allocation boundaries that the micro-scheduler is not permitted to exceed, the allocation unit may be configured to comply with the policy assigned to a suggested allocation.

The scheduler may comprise a monitoring unit configured to provide feedback to the other scheduler on the relative success of a particular allocation of communication resources.

The allocation unit may be configured to allocate communication resources to one or more of the terminals in the cell in order to provide feedback to the other scheduler on the relative success of that allocation.

The monitoring unit may be configured to provide the feedback to the other scheduler to assist it in scheduling communications with other terminals.

The allocation unit may be configured to allocate communication resources to others of the terminals in the cell in dependence on the relative success of the allocation of communication resources to the one or more terminals.

The scheduler may be configured to allocate the communication resources to the one or more terminals to assist in scheduling communications with terminals that are less flexible in their resource requirements than the one or more terminals.

The scheduler may be configured to, responsive to a command from the other scheduler, operate in a survey mode of operation in which it allocates the communication resources available to the cell to gather information about interference in the cell.

The scheduler may be configured to command a base station to enter a survey mode of operation in which it operates to gather information about interference in the cell.

The scheduler may be configured to command the one or more terminals to enter a survey mode of operation in which they use communication resources allocated to them to gather information about interference in the cell.

The scheduler may be configured to allocate resources on a frame-by-frame basis.

The scheduler may comprise a communication unit configured to communicate with another scheduler, which is configured to allocate communication resources between terminals in a different cell, the allocation unit being configured to allocate communication resources between the terminals in the one cell in dependence on information received from the other scheduler.

According a fifth embodiment, there is provided a method for allocating communication resources to terminals that are operating in a communication network comprising a plurality of cells, the method comprising a scheduler: allocating, for the plurality of cells, the communication resources available to each cell between the terminals in that cell using a first scheduling algorithm; designating an allocation of communication resources to a terminal as mandatory or suggested; and communicating the allocations and their associated designations to another scheduler.

According to a sixth embodiment, there is provided a method for allocating communication resources to terminals that are operating in a cell of a communication network, the method comprising a scheduler: receiving an allocation of communication resources between the terminals in the cell from another scheduler; and allocating the communication resources available to the cell between the terminals in the cell using: (i) the other scheduler's allocation of communication resources between those terminals; and (ii) a scheduling algorithm that is different from the scheduling algorithm used by the other scheduler to generate the received allocation of communication resources.

### BRIEF DESCRIPTION OF THE DRAWINGS

The present invention will now be described by way of example with reference to the accompanying drawings. In the drawings:

FIG. 1 shows an example of a communication network;

FIG. 2 shows an example of a method for allocating communication resources;

FIG. 3 shows an example of a macro-scheduler; and

FIG. 4 shows an example of a micro-scheduler.

### DETAILED DESCRIPTION OF THE INVENTION

Scheduling is the process whereby a communication network decides what resources to allocate to a particular device and for what purpose. A scheduler may comprise a macro-scheduler and a micro-scheduler.

The macro-scheduler may be configured to allocate the communication resources of a plurality of cells. The macro-scheduler may allocate the communication resources of those cells between the terminals in each cell using a first scheduling algorithm. The macro-scheduler is thus configured to allocate communication resources to terminals that are located across network. Suitably the macro-scheduler operates at a higher level in the communication network than the micro-scheduler. For example, the macro-scheduler may form part of the core network. It has an overview of multiple cells.

The micro-scheduler may be configured to allocate the communication resources available to one cell between the terminals in that cell. It might do this for multiple cells individually. It performs this allocation using a second scheduling algorithm. It also takes the macro-scheduler's allocation of communication resources between the relevant terminals into account. Suitably the micro-scheduler operates at a lower level in the communication network than the macro-scheduler. For example, the macro-scheduler may be implemented as part of a base station or a base station controller. It will have an overview of fewer cells than the macro-controller (typically just one).

A result of this arrangement is that there are two distinct scheduling algorithms running on different devices in the network and at different levels of the network. Both scheduling algorithms are used to schedule resources for the same terminals.

It may be possible to achieve greater system performance by performing at least some scheduling at a higher level of the network than is conventional. A macro-scheduler is able to take into account information that is unavailable to individual base stations to achieve a better solution to scheduling throughout the system. It may also take decisions that could degrade performance in a single cell, in order to maximise performance for the system as a whole. Decisions such as this are not possible without performing scheduling at a macro-level. Using a macro-scheduler may also help off-load some processing from the base stations, allowing them time to perform other tasks.

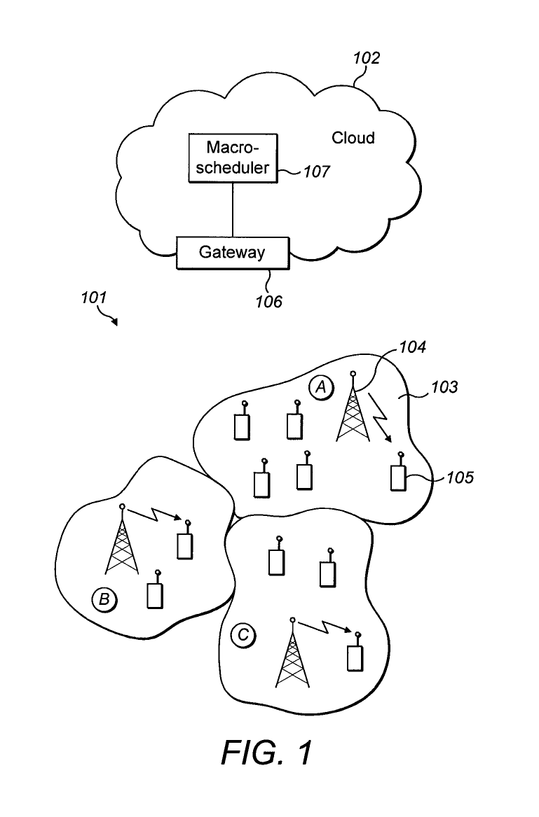

An example of a communication network is shown in FIG. 1. The communication network, shown generally at 101, comprises a plurality of cells 103 and a core network 102. In this example the core network is implemented in a cloud and is accessed via gateway 106. Each cell comprises a base station 104, which communicates with the terminals 105 in its cell via radio signals. Each base station has an overview of its particular cell; the micro-scheduler may suitably be implemented as part of a base station. The core network has an overview of multiple cells; suitably the macro-scheduler is implemented as part of the core network. For example, the macro-scheduler may be implemented by a supercomputer in the cloud.

The scheduler described herein may be used to allocate communication resources between devices in the network in accordance with any suitable multiple access technique. There are a number of ways limited communication resources can be divided between multiple users. Examples include TDMA (Time Division Multiple Access), FDMA (Frequency Division Multiple Access), CDMA (Code Division Multiple Access), OFDMA (Orthogonal Frequency Division Multiple Access) and SDMA (Space Division Multiple Access). Many networks will employ more than one of these techniques.

The macro-scheduler may divide the available bandwidth between neighbouring cells so that each cell has an assigned group of channels. This may help to minimise interference between adjacent cells as the macro-scheduler can ensure that adjacent cells do not use the same frequencies simultaneously. The communication network might also perform frequency hopping. The macro-scheduler may allocate a frequency hopping sequence to each cell. Adjacent cells may then cycle through the same group of frequencies, providing that they each “hop” onto a different frequency in the group.

A base station may use a frame structure to organise communications with the plurality of terminals in its cell. Medium access control (MAC) may be used to share the available bandwidth on a time-division basis. Each frame may be divided up into time slots that can be allocated to uplink or downlink transmissions. Preferably the macro-scheduler also knows the frame structure. The frequency hopping sequence may be timed so that each frame occurs on a different “hop” in the sequence. In this example, allocating a terminal a particular time slot for an uplink or downlink communication is equivalent to allocating that terminal a resource in terms of both frequency and time.

In an M2M network the terminals are likely to be tolerant of delays and missed packets, which gives the schedulers flexibility in scheduling communications with particular terminals. Many of the terminals are likely to be battery-powered, however, so they may need to have communications or rendezvous scheduled with the network in advance so that they can operate in a power-saving mode in the meantime.

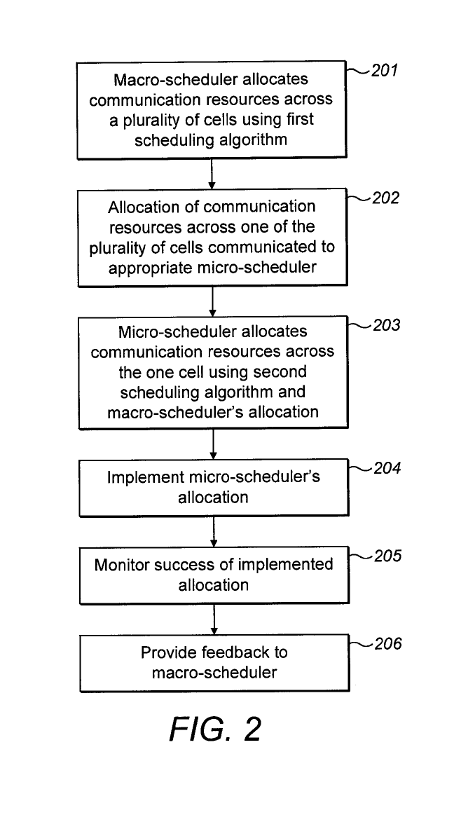

An overview of a method for allocating communication resources between terminals in a communication network is shown in FIG. 2. The method comprises the macro-scheduler allocating resources to terminals in each cell of a plurality of cells using a first scheduling algorithm (step 201). This step causes resources to be allocated to terminals located across the plurality of cells. This allocation is then communicated to the appropriate micro-schedulers (step 202). The micro-schedulers do not automatically follow the macro-scheduler's allocations. There are a number of reasons for this. First, the micro-scheduler may be aware of some relevant local conditions that the macro-scheduler knows nothing about. Second, the micro-scheduler may have to allocate resources to communications or terminals that the macro-scheduler is not concerned with. An example is control traffic, which the micro-schedulers are likely to have sole responsibility for. A third reason is that some of the macro-scheduler's allocations may take the form of suggestions or guidance for the micro-scheduler, as opposed to a mandatory instruction that must be followed (this is described in more detail below). Consequently, in step 203, the micro-scheduler performs its own allocation of communication resources using a second scheduling algorithm and the macro-scheduler's allocation. The micro-scheduler's allocation is the allocation that is put into practice (step 204). In a further optional step, the micro-scheduler may monitor the success of the final, implemented allocation (step 205) and feed this back to the macro-scheduler (step 206).

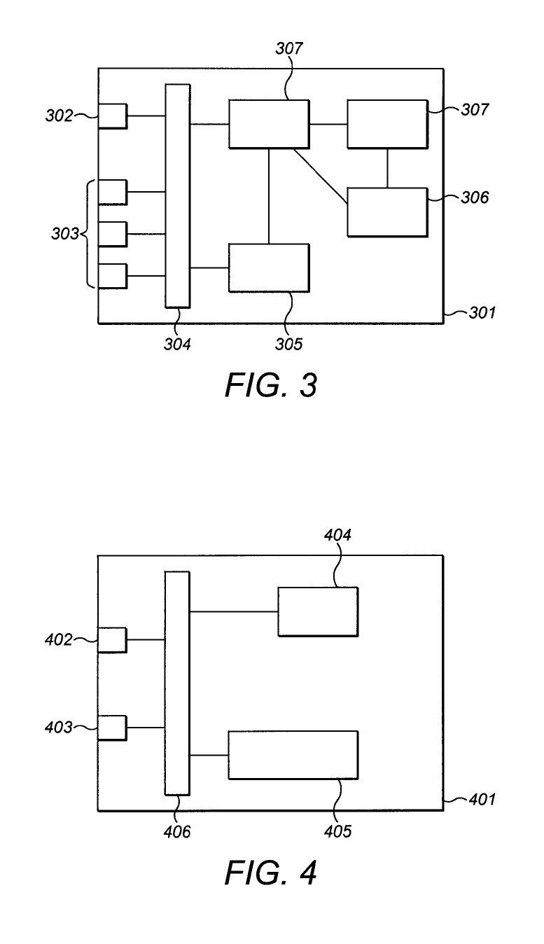

An example of a macro-scheduler is shown in FIG. 3. The macro-scheduler, shown generally at 301, comprises an input 302 for receiving information from the core network and multiple inputs 303 for receiving information from and transmitting information to the micro-schedulers. The macro-scheduler may transmit and receive information with other devices via either wired or wireless means. The macro-scheduler comprises communication unit 304 for processing received information and information to be transmitted. A scheduling unit 307 for determining allocations of communication resources using the first scheduling algorithm and a feedback unit 305 for receiving feedback from the micro-schedulers in different cells about how the implemented resource allocations have performed in practice are connected to the communication unit. The feedback unit is connected to the scheduling unit, along with the designation unit 307 and policy unit 306, which determine whether allocations should be designated as mandatory or suggested and any boundaries restrictions that should be set for suggested allocations.

A macro-scheduler may take inputs from both the individual cells and the core network. Examples of suitable inputs may include (but are not limited to):
Terminal power profile (e.g. battery powered or mains powered)
Terminal sleep profile (times at which the terminal should be awake)
Terminal rendezvous points (times at which the terminal is expecting to communicate with the network)
Permitted channels for use in a cell or by a terminal, e.g. channels that are permitted by a regulator, a licence holder or covered by the terms of a licence
Past terminal performance on particular channels
Composition of terminals and terminal properties in a cell and its neighbours
Data queued for downlink transmission and the traffic expected in the uplink
Regulations restricting the behaviour of terminals operating in the bandwidth, e.g. duty cycles imposed on terminals operating in the ISM band, regulations governing the sum-of-energy from a given device
Commercial agreements with terminal operators, such as Quality of Service (QoS) terms agreed, penalty clauses, price per octet etc.

An example of a micro-scheduler is shown in FIG. 4. The macro-scheduler, shown generally at 401, comprises an input 402 for exchanging information with the macro-scheduler and an input 403 for exchanging information with one or more base stations. The micro-scheduler may exchange information with the macro-scheduler via either wired or wireless means. The micro-scheduler comprises a scheduling unit 404 that receives scheduling information from the macro-scheduler and uses that as an input to its own second scheduling algorithm. It also comprises a monitoring unit 405 for keeping track of how the implemented resource allocations are performing in practice. The monitoring unit may, for example, keep track of which transmissions have been acknowledged by the terminals and which transmissions from the terminals have been successfully received by the base station. It also comprises a communication unit 406 for handling the exchanges of information with other devices.

The micro-scheduler may be implemented as part of a base station, in which case input 403 may be connected to the base station's communication unit for receiving and transmitting communications with terminals over the air-interface. In some embodiments the micro-scheduler may be implemented as part of a base station controller. For example, in some arrangements the base station may be a very simple device that consists of a modem and a radio. The base station controller may format the frames and pass them to the base station for transmission. The base station controller could, for example, be implemented as a virtual machine running on a PC.

A micro-scheduler may take inputs from both the individual cells and the macro-scheduler. Examples of suitable inputs may include (but are not limited to):
Allocations of communication resources made by the macro-scheduler Policies associated with any suggested allocations proposed by the macro-scheduler
Terminal power profile (e.g. battery powered or mains powered)
Terminal sleep profile (times at which the terminal should be awake)
Terminal rendezvous points (times at which the terminal is expecting to communicate with the network)
Permitted channels for use in a cell or by a terminal, e.g. channels that are permitted by a regulator, a licence holder or covered by the terms of a licence
Past terminal performance on particular channels
Composition of terminals and terminal properties in the cell
Data queued for downlink transmission and the traffic expected in the uplink
Regulations restricting the behaviour of terminals operating in the bandwidth, e.g. duty cycles imposed on terminals operating in the ISM band, regulations governing the sum-of-energy from a given device
Control traffic to be sent to the terminals

The schedulers shown in FIGS. 3 and 4 are shown as comprising a number of functional blocks. This is for illustrative purposes only. It is not intended to define a strict division between different parts of hardware on a chip or between different programs, procedures or functions in software. In some embodiments, some or all of the algorithms described herein may be performed wholly or partly in hardware. In many implementations, at least part of the communication apparatus may be implemented by a processor acting under software control.

The macro-scheduler and the micro-schedulers work in tandem. Each scheduler performs the type of scheduling which it is best able to perform. Some types of scheduling are best performed at a local level (and hence by the micro-scheduler). Local scheduling may be preferred for some types of scheduling, for example, because it can offer lower latency, more accurate time allocations and more relevant cached data. Other tasks may be more easily performed at a higher-level where more system information is available (and hence by the macro-scheduler).

The macro-scheduler is preferably configured to perform high-level planning. It may allocate communication resources for frames that stretch a number of frames into the future. The macro-scheduler aims to optimise the allocation of resources across a plurality of cells. It may sacrifice the performance of individual cells in order to achieve this. For example, the macro-scheduler might mute a particular cell for one or more frames to allow another cell with higher-priority traffic to use a specific frequency or code. It might also allow a particular base station longer for its communications than another, to enable it to better handle retransmissions. This might be applicable in a scenario in which the base stations share the available frequencies on a TDMA basis.

The micro-scheduler is preferably configured to implement an actual resource allocation. It may perform this allocation on a frame-by-frame basis. It is suitably configured to optimise its resource allocation for its particular cell.

The macro-scheduler may provide mandatory allocations and suggested allocations to the micro-schedulers. In one embodiment this information may take the form of frame layouts. Suggested allocations may take the form of “hints” or guidance to the micro-scheduler. The micro-scheduler would be required to use the mandatory parts of the scheduling information but would be free choose whether to ignore the suggested allocations when building its frames. The micro-scheduler may ignore a suggested allocation, for example, if it determines that it would be non-optimal for its cell or if it can perceive a benefit in overriding the macro-scheduler's allocation.

The macro-scheduler may decide whether to make a resource allocation mandatory or suggested depending on how the network is operating. The macro-scheduler may start with a relatively loose strategy, with a high proportion of suggested allocations, until it starts to receive feedback from the micro-schedulers and starts to “learn” the network. The macro-scheduler may issue more mandatory allocations if feedback from the micro-schedulers indicate that its allocations are being adopted and performing well. Conversely, if feedback shows that its allocations are not performing well in practice, the macro-scheduler may scale back on its mandatory allocations in an attempt to “relearn” the network (e.g. if communication conditions in the network have changed due to a sudden change in traffic or the introduction of a new interferer). If the network is struggling to cope with traffic, the macro-scheduler may shift the balance towards mandatory allocations. The macro-scheduler may allocate different proportions of mandatory and suggested allocations for different cells.

Other considerations about whether to make an allocation mandatory or not may be terminal specific. For example, the costs incurred in communicating with some terminals (e.g. battery-powered terminals) might be higher than the costs of communicating with others. Missing some slots might have a big impact on future demands on the cell, particularly if the terminal in question is likely to be aggressive about trying to obtain access to the network if its slot is missed. Other slots might be comfortably missable. In general, both schedulers should be configured to prioritise scheduling for terminals that will be difficult or costly to reach at another time if their scheduled slot is missed. (Battery-powered terminals, for example, may only exit power-saving mode for a pre-scheduled communication slot and may re-enter power-saving mode if that slot is missed.) The macro-scheduler may also take commercial drivers into account, such as QoS terms that make it financially costly to miss scheduled slots with terminals belonging to certain customers. The micro-scheduler is unlikely to see such commercial drivers at its lower level.

The macro-scheduler may define a policy to accompany any suggested allocation. The policy may set out boundaries within which the micro-scheduler may vary the suggested allocation. Those boundaries may not be breached by the micro-scheduler. As an example, the macro-scheduler might suggest that the micro-scheduler communicate with a terminal in a particular time slot, but permit the micro-scheduler to vary that allocation providing that the communication still occurs in the same frame.

The micro-scheduler may need the flexibility afforded by suggested allocations to handle traffic that the macro-scheduler does not always see at the higher level. For example, the micro-scheduler will typically schedule control traffic for the terminals. It will also have to handle retransmissions and any asynchronous requests from terminals. The micro-scheduler has to fit this traffic in around any allocations for data transfer that have been stipulated by the macro-scheduler.

The micro-scheduler may be configured to provide feedback to the macro-scheduler on one or more of the following: what schedule was adopted, some indication of the micro-scheduler's decision making process (e.g. what suggestions from the macro-scheduler were adopted and which were rejected, and the reasons for that). This could also include what interferers are apparent to which terminals. This feedback may help the macro scheduler to make better decisions. The macro-scheduler may also use the information from one cell to assist its allocation for another cell. For example, the macro-scheduler could derive information about localised interferers from this micro-scheduler feedback, and could provide suggestions to other cells accordingly.

The macro-scheduler might also commission a survey of the network by causing the micro-scheduler to schedule communications for experimental or measurement purposes. This would give the macro-scheduler additional information, enabling it to derive a superior scheduler. The macro-scheduler may also commission a survey in response to changes in the RF performance of the network. This might be due to a degradation in performance or changes in the topology of the network, e.g. adding a new base station.

The macro-scheduler may be configured to identify terminals that are best suited for handling such survey communications. This may be because a terminal is well-placed to provide the macro-scheduler with information it wants to know, e.g. the terminal is in a particular location or has a particular physical attribute such as a directional antenna. It may be because the terminal can handle additional communications without significant cost, e.g. the terminal is mains-powered.

This would involve additional commands between the network and the micro-scheduler, and between the micro-scheduler and the terminals (via the base stations). This may generally involve one or more of the micro-scheduler, the base station and the terminals entering a survey mode of operation in which they operate to gather information about interference in the network, and in particular in the relevant cell in which they operate. The macro-scheduler may command the micro-scheduler to enter the survey mode. The micro-scheduler may be implemented as part of a base station; if it is not implemented as part of a base station, the micro-scheduler may command the base station to enter the survey mode. The base station may command the terminals to enter the survey mode. The base station may be provided with a list of standard commands that it can send to terminals. Possibilities could include having the terminal detect other base stations in the vicinity, and then transmit the results of that survey back to the first base station, and reporting to the base station about interference received on a particular frequency. The base station may send these commands under the control of the micro-scheduler.

This type of probing could be used to come up with the best possible resource allocations for terminals with the most sensitive and demanding of scheduling requirements, e.g. by choosing the best possible time slots, channels or codes. The probing itself may be performed using terminals whose scheduling requirements are more relaxed.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A scheduler for allocating communication resources to terminals that are operating in a communication network comprising a plurality of cells, the scheduler comprising:
a macro-scheduler configured to, for the plurality of cells, allocate the communication resources available to each cell between the terminals in that cell using a first scheduling algorithm; and
a micro-scheduler configured to allocate the communication resources available to one of the cells between the terminals in that cell using: (i) the macro-scheduler's allocation of communication resources between those terminals; and (ii) a second scheduling algorithm.

2. A scheduler as claimed in claim 1, the macro-scheduler being configured to prioritise one cell over another if it determines that this is likely to increase performance across the plurality of cells.

3. A scheduler as claimed in claim 1, the macro-scheduler being configured to designate an allocation of communication resources to a terminal as mandatory or suggested.

4. A scheduler as claimed in claim 3, the micro-scheduler being configured to not to implement the suggested allocation if it determines that not implementing it is likely to increase performance across the one cell.

5. A scheduler as claimed in claim 3, the macro-scheduler being configured to assign a policy to a suggested allocation which sets out conditions under which the micro-scheduler is permitted not to implement the suggested allocation.

6. A scheduler as claimed in claim 1, the micro-scheduler being configured to provide feedback to the macro-scheduler on the relative success of a particular allocation of communication resources in the one cell.

7. A scheduler as claimed in claim 1, the macro-scheduler being configured to allocate communication resources between the terminals in the one cell in dependence on feedback it has received from the micro-scheduler.

8. A scheduler as claimed in claim 1, the macro-scheduler being configured to allocate communication resources between terminals in one cell in dependence on feedback it has received about the relative success of an allocation of communication resources in another cell.

9. A scheduler as claimed in claim 1, the macro-scheduler being configured to allocate communication resources to one or more terminals in the one cell in order to receive feedback from the micro-scheduler on the relative success of that allocation.

10. A scheduler as claimed in claim 9, the macro-scheduler being configured to allocate the communication resources to the one or more terminals in order to receive feedback to assist it in scheduling communications with other terminals.

11. A scheduler as claimed in claim 10, the macro-scheduler being configured to allocate the communication resources to one or more terminals to assist in scheduling communications with terminals that are less flexible in their resource requirements than the one or more terminals.

12. A scheduler as claimed in claim 1, the macro-scheduler being configured to command the micro-scheduler to enter a survey mode of operation in which the micro-scheduler allocates communication resources between the terminals in the cell to gather information about interference in the cell.

13. A scheduler as claimed in claim 12, the micro-scheduler being configured to, responsive to the macro-scheduler's command, command a base station to enter a survey mode of operation in which it operates to gather information about interference in the cell.

14. A scheduler as claimed in claim 12, the micro-scheduler being configured to, responsive to the macro-scheduler's command, command the one or more terminals to enter a survey mode of operation in which they use communication resources allocated to them to gather information about interference in the cell.

15. A scheduler as claimed in claim 1, the macro-scheduler being configured to communicate with another micro-scheduler, which is configured to allocate communication resources between terminals in a different cell from the one cell, and to allocate communication resources between the terminals in the one cell in dependence on information received from the other micro-scheduler.

16. A scheduler for allocating communication resources to terminals that are operating in a communication network comprising a plurality of cells, the scheduler comprising:
an allocation unit configured to, for the plurality of cells, allocate the communication resources available to each cell between the terminals in that cell using a first scheduling algorithm;
a designation unit configured to designate an allocation of communication resources to a terminal as mandatory or suggested; and
a communication unit configured to communicate the allocations and their associated designations to another scheduler.

17. A scheduler as claimed in claim 16, the scheduler comprising a policy unit configured to assign a policy to a suggested allocation which sets out conditions under which the other scheduler is permitted not to implement the suggested allocation.

18. A scheduler as claimed in claim 17, the policy unit being configured to assign a policy which sets out allocation boundaries within which the other scheduler is permitted to vary the macro-scheduler's suggested allocation.

19. A scheduler as claimed in claim 17, the policy unit being configured to assign a policy which sets out allocation boundaries that the other scheduler is not permitted to exceed.

20. A scheduler for allocating communication resources to terminals that are operating in a cell of a communication network, the scheduler comprising:
an input configured to receive an allocation of communication resources between the terminals in the cell from another scheduler;
an allocation unit configured to allocate the communication resources available to the cell between the terminals in the cell using: (i) the other scheduler's allocation of communication resources between those terminals; and (ii) a scheduling algorithm that is different from the scheduling algorithm used by the other scheduler to generate the received allocation of communication resources.
